(19) United States
(12) Patent Application Publication
(10) Pub. No.: US 2012/0285764 A1
(43) Pub. Date: Nov. 15, 2012

(54) UNIVERSAL CROSS MEMBER

(76) Inventor: L. Brooks Compton, Las Vegas, NV (US)

(21) Appl. No.: 13/106,774

(22) Filed: May 12, 2011

(51) Int. Cl. B62D 21/00; B23P 17/04

(52) U.S. Cl. 180/312; 29/428

(57) ABSTRACT

A universal cross member secures a variety of transmissions within various vehicles, and allows installed transmissions to be exchanged for different transmissions. The universal cross member may comprise a plurality of arms supporting a body. The body may have one or more elongated, circular, or other slots to allow various transmissions to be attached thereto. An adjustment pad having a particular thickness and its own slots may be provided to support additional transmissions. The universal cross member may have cambered arms that extend upward towards the body of the cross member. In addition, a plurality of to throughbores may be at the distal ends of the arms to allow the universal cross member to be attached at various locations within a vehicle.

### BACKGROUND OF THE INVENTION

1. Field of the Invention

The invention relates to vehicle mounting structures, and in particular to a universal transmission mount for mounting a wide variety of transmissions within a wide variety of vehicles.

2. Related Art

A crucial part of a vehicle's drive train is its transmission. The transmission transfers power from the vehicle's engine to its wheels. As such, the transmission must be securely supported to the vehicle's frame. Traditionally, transmissions have been supported and secured to a vehicle's frame by one or more mounts. As such, a vehicle's transmission mount is traditionally designed to secure its particular transmission. Improper mounting of a vehicle's transmission can cause increased noise and vibration, and in some cases may damage drive train components.

From the discussion that follows, it will become apparent that the present invention addresses the deficiencies associated with the prior art while providing numerous additional advantages and benefits not contemplated or possible with prior art constructions.

### SUMMARY OF THE INVENTION

A universal cross member for securing a variety of transmissions within various vehicles is disclosed herein. The universal cross member contains a number of elements and features which allow it to securely hold almost any transmission at a desired location within a vehicle, such as within the vehicle's engine bay. This allows a user to install almost any transmission into his or her vehicle. In addition, the versatility of the universal cross member ensures that a desired pinion angle can be set for the vehicle's drive train components. The universal cross member can be constructed from various materials, including aluminum.

In one embodiment, as will be described further herein, the universal cross member may comprise a body having one or more elongated slots configured to accept a fastener at one or more points along their length to secure the transmission to the body. A pair of support arms may extend outward from opposite sides of the body substantially parallel to the body, and a plurality of throughbores may be at the distal ends of the each support arms. The plurality of throughbores may be configured to accept a fastener to secure the universal cross member to the vehicle, and may be at different positions at the distal ends of the support arms.

A sloped section may be at the proximal end of each of the support arms. The sloped sections may be configured to position the pair of support arms at a different elevation than the body. The sloped sections may be angled sections between the support arms and the body that cause the body to be elevated above the support arms. In addition, the sloped sections may be angled such that the pair of support arms are substantially parallel to the body. It is noted that the pair of support arms may extend at an angle rearward from the body.

The universal cross member may also include an adjustment pad having one or more elongated slots therein. The adjustment pad may be permanently or removably secured to the body, and allows the vertical position at which a transmission is mounted to be adjusted. For example, including an adjustment pad may raise the position of the transmission.

In an alternate exemplary embodiment, the universal cross member may comprise a planar body having one or more elongated slots configured to accept a fastener along their lengths to secure the transmission to the planar body. It is noted that there may be multiple elongated slots that are parallel to one another in the planar to body. A first arm may extend outward from a first side of the planar body, while a second arm may extend outward from a second side of the planar body. One or more first throughbores may be at the distal end of the first arm. One or more second throughbores may be at the distal end of the second arm. The first throughbores may be larger than the second throughbores in at least one dimension.

The first arm and the second arm may have one or more vertical angles configured to position at least the distal end of the first arm and at least the distal end of the second arm at a different elevation than the planar body. The vertical bends may be such that the first arm and the second arm are substantially parallel to the body while at a lower elevation than the body. One or more horizontal bends may be in the first arm and the second arm to position at least the distal end of the first arm and at least the distal end of the second arm rearward of the body.

A planar adjustment pad comprising one or more openings may be attached to the body. If provided, the planar adjustment pad may be attached to the body by one or more fasteners inserted into the openings of the planar adjustment pad and the elongated slots of the body.

Various methods of securing a transmission using a universal cross member are also disclosed herein. For example, in one embodiment, a method for securing a transmission within a vehicle is disclosed. Such method may comprise positioning a universal cross member comprising a body, a first arm, and a second arm within a vehicle such that the body is at a different elevation than at least a portion of the first arm and at least a portion of the second arm.

Once positioned, at least one first throughbore at a distal end of the first arm of to the universal cross member may be selected. The distal end of the first arm may be attached to a portion of the vehicle using the selected first throughbore. A distal end of the second arm of the universal cross member may then be attached to another portion of the vehicle. One or more fasteners may be located along the length of one or more elongated slots in the body to align the fasteners with one or more mounting structures (e.g., bolts, bolt holes, etc. . . . ) of the transmission. The transmission may be secured to the body by inserting the fasteners into the elongated slots, and coupling the fasteners with the mounting structures of the transmission. It is noted that at least one second throughbore may also be selected. The second throughbore may be at a distal end of the second arm of the universal cross member. The distal end of the second arm may then be attached to the vehicle using the selected at least one second throughbore.

An adjustment pad may be attached to the body of the universal cross member. In such case, the transmission may be secured to the elongated slots of the adjustment pad. The adjustment pad may be positioned to extend forward or rearward from the body of the universal cross member, such as to achieve a desired pinion angle.

The universal cross member allows transmissions to be swapped for different transmissions using various methods. For example, it is contemplated that at least one second throughbore may be selected at a distal end of the first arm of the universal cross member. The distal end of the first arm may then be attached to a portion of the vehicle using the second selected throughbore. A different transmission may then be attached to the body by inserting the fasteners into the elongated slots and one or more mounting structures of the different transmission. As can be seen, the second throughbore may be specifically selected to properly secure the different (i.e., new) transmission.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a top view of an exemplary universal cross member;

FIG. 1B is a top view of another exemplary universal cross member;

FIG. 1C is a top view of another exemplary universal cross member;

FIG. 1D is a top view of an exemplary adjustment pad of a universal cross member;

FIG. 1E is a top view of another exemplary adjustment pad of a universal cross member;

FIG. 2A is a perspective view of an exemplary universal cross member;

FIG. 2B is a perspective view of an exemplary adjustment pad of a universal cross member;

FIG. 2C is a front view of an exemplary universal cross member;

FIG. 3A is a top view of an exemplary universal cross member in a first configuration;

FIG. 3B is a top view of an exemplary universal cross member in a second configuration;

FIG. 3C is a top view of an exemplary universal cross member having an adjustment pad in a first configuration;

FIG. 3D is a top view of an exemplary universal cross member having an adjustment pad in a second configuration;

FIG. 4A is a side view illustrating use of an exemplary universal cross member with a vehicle drive train;

FIG. 4B is a side view illustrating use of an exemplary universal cross member and adjustment pad with a vehicle drive train;

FIG. 4C is a side view illustrating adjustment of the adjustment pad in securing a vehicle transmission; and

FIG. 4D is a side view illustrating adjustment of the adjustment pad in securing a vehicle transmission.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the universal cross member provides and adjustable support for a transmission. The universal cross member may be installed to a vehicle's frame and may be configured to raise or lower the transmission. In addition, the universal cross member may be configured to accept transmissions of various sizes and configurations.

It is often desirable for a vehicle owner, manufacturer, user, or the like to select a transmission with particular characteristics. For example, one individual may desire a transmission for racing while another desires a transmission more suitable for towing or hauling. Some people may even select a transmission for fuel efficiency. In addition, transmissions are configured to be compatible with various engines or motors. If an individual wishes to have a particular motor or engine, he or she should not be limited by a vehicle's particular transmission.

One advantage of the universal cross member is that it allows a wide variety of transmissions to be used in a wide variety of vehicles. This in turn allows a wide variety of engines or motors to be selected and used in virtually any vehicle. As will be detailed further below, the universal cross member provides this “universality” while ensuring that the combination of transmission, vehicle, and engine operate together properly.

The universal cross member also provides advantages over traditional mounts in terms of weight savings (while continuing to provide the benefits described above). This is highly advantageous to fuel economy, efficiency, and speed. In addition, the universal cross member's construction provides a unique flexibility not possible in traditional systems, as will be described further below.

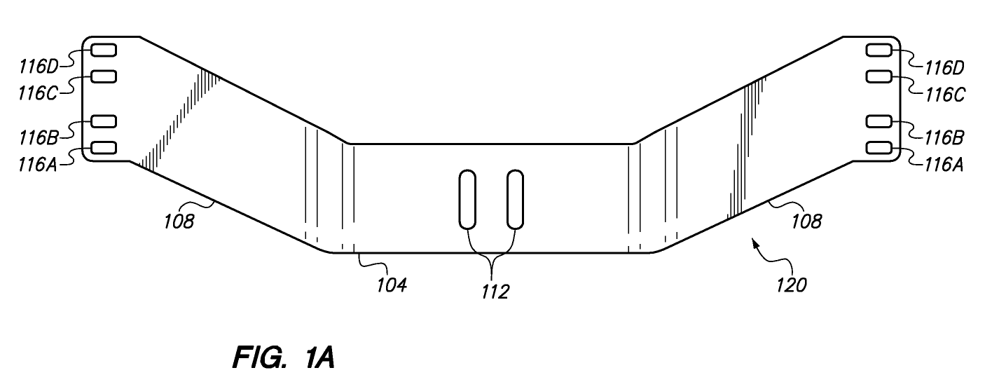

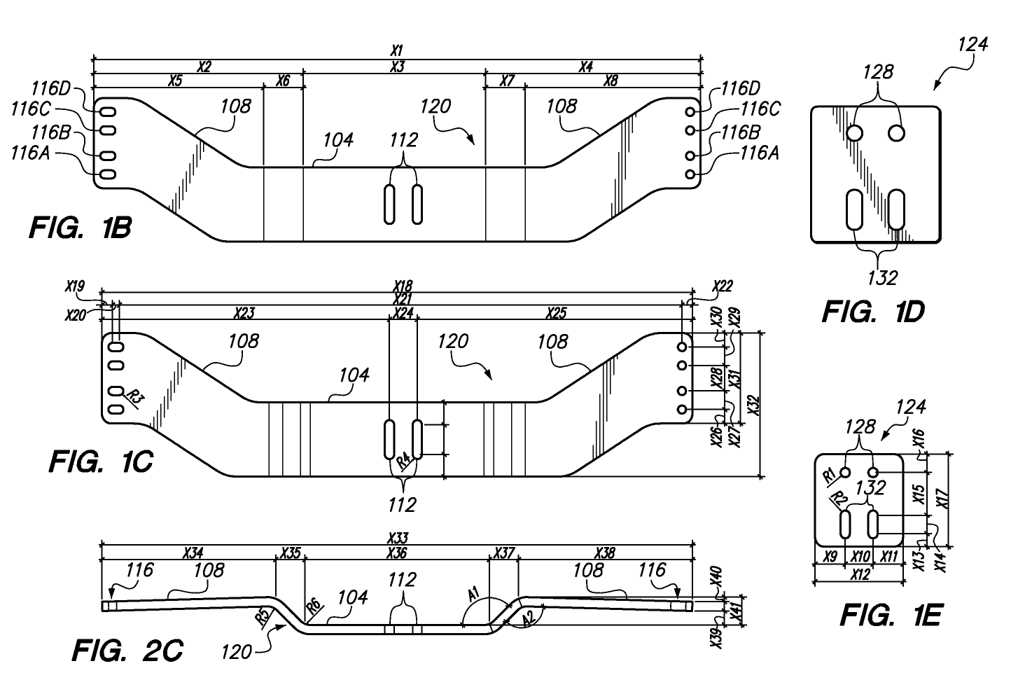

The universal cross member will now be described with regard to FIGS. 1A-1E. FIG. 1A is a top view of an exemplary universal cross member 120. As can be seen, the universal cross member 120 may comprise an elongated structure. In one or more embodiments, the elongated structure may be used to span across a distance between sections of a vehicle's frame, typically at the vehicle's engine bay (or where the vehicle's transmission is to be located). Typically, the universal cross member 120 will extend laterally when installed in a vehicle; though it is contemplated that the universal cross member may be oriented or angled in various directions.

In one or more embodiments, the universal cross member 120 may comprise a central portion or body 104. One or more support arms 108 may extend outward from the body 104 to form the elongated structure of the universal cross member 120. As can be seen from FIG. 1A for example, the support arms 108 extend from the sides of the body 104. The support arms 108 may extend a length sufficient to span between and attached to portions of a vehicle's frame. In this manner, the support arms 108 may attach to the vehicle frame and support the body 104 of the universal cross member 120. The body 104 may then support the vehicle's transmission.

As can be seen in FIG. 1A, the distal ends of the support arms 108 may have one or more throughbores 116. In general, these throughbores 116 allow the support arms 108 to be attached to a portion of a vehicle's frame. For example, a mechanical fastener, such as a bolt or pin, may be inserted into the throughbores 116 and a portion of the vehicle's frame to secure the support arms 108 to the frame. As can be seen, a series or set of throughbores 116 may be provided. This is highly beneficial in that it permits the universal cross member 120 to be mounted at various positions within an engine bay. For example, the position of the universal cross member 120 may be adjusted by selecting which one or more (typically at least one pair) or the throughbores 116 are used to attach the universal cross member to the vehicle. For example, securing the universal cross member 120 with throughbores 116A would to place the universal cross member at a first position relative to the vehicle's frame, while using throughbores 116C would put the universal cross member at a second position relative to the vehicle's frame.

It is contemplated that the throughbores 116 may have a rounded shape or be circular. Other shapes may be used as well, such as rectangular or square shapes. In addition, it is contemplated that matching pairs of throughbores 116 may have a similar shape that distinguishes pairs of through bores from other pairs. For example, throughbores 116A may have a first shape while the other throughbores 116B,116C,116D have different shapes. To illustrate, throughbores 116A may be square or rectangular, while other pairs of throughbores have non-rectangular shapes. Such matching is beneficial in that it allows a user to easily identify which throughbore 116 to use. For example, to properly align the universal cross member 120, a user may attach the universal cross member to the vehicle using throughbores 116A (or other matching throughbores) on both ends of the universal cross member.

In some embodiments, throughbores 116 on one arm 108 of the universal cross member 120 may have a different shape than a corresponding throughbore on the cross member's other arm. For example, throughbore 116A on a first arm 108 may be elongated or enlarged, while throughbore 116A on a second arm 108 may be rounded. The elongated or enlarged throughbore 116 can make aligning the universal cross member 120 with a vehicle easier, which in turn makes fastening the universal cross member to the vehicle at the throughbores easier.

The support arms 108 may extend outward in various ways. For example, as shown in FIG. 1A, the support arms may extend at an angle relative to the body 104. Stated another way, the universal cross member 120 may have one or more horizontal angles which adjust the position of the arms, such as shown. This alters the horizontal profile of the universal cross member 120 (as can be seen in the top view of FIG. 1A).

The angle of the arms 108 relative to the body 104 is beneficial in positioning the body 104 at a location where it may support a vehicle's transmission. The support arms 108 may extend at different angles. For example, the support arms 108 may extend straight outward parallel to the body 104 in some embodiments. In other embodiments, the support arms 108 may extend at an increased or decreased angle than that shown. Referring to the view of FIG. 1A for example, the distal ends of the support arms 108 may be further below the body 104 to increase the angle of the support arms relative to the body. The distal ends may be moved up to decrease the angle. It is noted that the support arms 108 may be angled in different directions as well.

As stated above, the body 104 may provide support to a vehicle's transmission. In one or more embodiments, the body 104 may include one or more elongated throughbores or slots 112. In one or more embodiments, the elongated slots 112 allow a transmission to be secured to the body 104, such as by one or more fasteners, such as threaded bolts. As will be described further below, the elongated slots 112 provide the benefit of allowing a transmission to be secured to at various locations along the elongated slots.

FIGS. 1B-1C illustrates additional exemplary embodiments of the universal cross member 120. As can be seen, the arms 108 and body 104 of the universal cross member 120 may have a variety of configurations. For instance, FIGS. 1B-1C illustrate universal cross members 120 having throughbores 116 of different shapes/sizes, among other things. In addition, FIGS. 1B-1C provide references to dimensions for various elements of the universal cross member 120. Some dimensions that beneficial in that they have been discovered to permit the universal cross member 120 to be used in a wide range of vehicles and with a variety of transmissions will be disclosed below.

Referring now to FIG. 1D, it can be seen that the universal cross member 120 may include an adjustment pad 124 in some embodiments. In general, the adjustment pad 124 provides additional adjustment capability while preserving the universal cross member's ability to securely mount a vehicle's transmission. It is noted that FIG. 1E illustrates a particular embodiment of an adjustment pad 124. As can be seen, FIG. 1E provides references for dimensions for the adjustment pad 124, which will be detailed further below. Various adjustment pads 124 will now be described.

As can be seen, the adjustment pad 124 may comprise one or more mounting holes 128. The mounting holes 128 may be used to fasten or attach the adjustment pad 124 to the universal cross member 120. For example, a fastener, such as a bolt, may be inserted into the mounting holes 128 of the adjustment pad 124 and elongated slots 112 of the body 104 and secured to attach the adjustment pad 124 to the body.

The mounting holes 128 may be sized and/or shaped to accept the fastener used to secure the adjustment pad 124. For example, as shown, the mounting holes 128 are circular and have a diameter configured to accept a bolt, pin, or other mechanical fastener therein. In this manner, the mounting holes 128 locate the position of the mechanical fasteners used to attach the adjustment pad 124 to the universal cross member 120. As will be discussed further below, since the adjustment pad 124 may be attached using the elongated slots 112 of the body 104, the adjustment pad may be located at various locations along the length of the elongated slots.

The adjustment pad 124 may have its own one or more elongated slots 132. In general, these elongated slots 132 serve as replacements for the elongated slots 112 of the body 104. This is because the body's elongated slots 112 may be used to secure the adjustment pad 124 to the universal cross member 120 as described above. Like the elongated slots 112 of the body 104, these elongated slots 132 may be used to secure a transmission to the universal cross member 120. The length of the elongated slots 132 allow a transmission to be attached at various positions on the adjustment pad 124. Since the adjustment pad 124 itself has an adjustable position, it can be seen that the adjustment pad expands the adjustability of the universal cross member 120 in that it permits a transmission to be supported at various positions.

In general, the elongated slots 112,132 of the body 104 and adjustment pad 124 allow the location at which the universal cross member 120 supports a transmission to be changed in a horizontal direction. The location at which a transmission is supported may also be vertically adjustable using the universal cross member 120. For example, the universal cross member 120 may be formed to various heights. Alternatively or in addition, the adjustment pad 124 may be various heights or thicknesses to raise or lower the position of a transmission when mounted to the universal cross member 120.

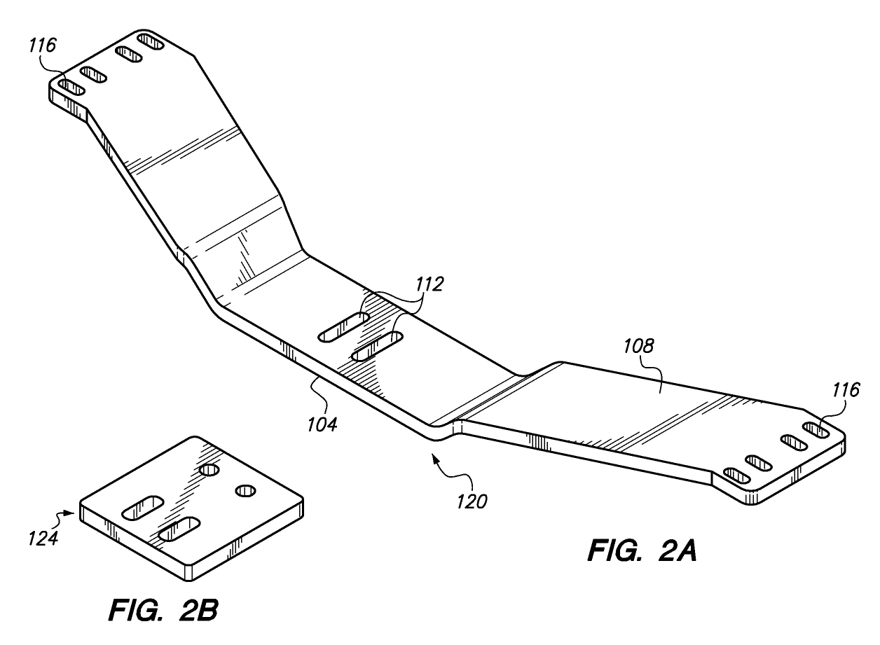

Referring to FIG. 2A, it can be seen that the elongated structure of the universal cross member 120 may have multiple elevations (e.g., raised and lowered portions). As shown for example, the universal cross member 120 may have a raised and lowered sections. To illustrate, the body 104 may be at a different elevation than the support arms 108. As shown in FIG. 2A, the body 104 is lower than the support arms 108 for example. This allows the universal cross member 120 to hold a transmission at a particular elevation. It is contemplated that the difference in elevation between the body 104 and support arms 108 may be increased or decreased.

The universal cross member 120 may have one or more sloped or angled portions 204 between the body 104 and the support arms 108 to generate its height. As shown in FIGS. 2A and 2C for example, the universal cross member 120 has vertical angles at the angled portions 204 which lower the body 104 below the arms 108. In some embodiments, the amount the body 104 is lowered may be altered, such as by adjusting reducing or increasing the angles 208,212 at the angled portions 204 of the universal cross member 120. Alternatively, the downward extending sections of the universal cross member 120 at the angled portions 204 may be lengthened or shortened to adjust the position of the body 104 relative to the arms 108. FIG. 2C provides references for dimensions of the universal cross member 120 which will be detailed further below.

The sloped or angled portions 204 of the universal cross member 120 may be various shapes. For example, the universal cross member 120 may have a tilted “S” shaped angled portion 204 having one or more bends or angles 208,212 like that shown in FIGS. 2A and 2C. The sloped or angled portions 204 on either side of the body 104 may be the same or similar to ensure that both arms 108 are at the same elevation relative to the body 104. This allows the body 104 to be held parallel to the mounting structures of the vehicle when the universal cross member 120 is installed. It is contemplated that one arm 108 may be higher than another arm, such as to accommodate a vehicle without mounting structures that are not even or that are at different elevations.

It is contemplated that the sloped or angled portions may be configured to hold the arms 108 parallel or substantially parallel to the body 104. Typically, the arms 108 will be cambered so as to be angled slightly relative to the body 104. As can be seen from FIG. 2C for example, each arm 108 extends at a slight upward angle from its distal end to its proximal end (where it connects to the angled portions 204). When under load, such as when a transmission is being supported by the body 104, the camber may be reduced or eliminated. In one or more embodiments, under load, the arms 108 may flatten out such that they are parallel or substantially parallel to the body 104. In this manner, the camber helps compensate for the weight of the transmission when the universal transmission mount 120 is installed.

The camber of the arms 108 may be generated by one or more of the angles at the angled portions 204 of the universal cross member 120. For instance, as shown in FIGS. 2A and 2C, the outer bend or angle 212 at the angled portions 204 controls the angle or camber of the arms. As can be seen, by adjusting the outer angle 212, the camber of the arms 108 can be adjusted accordingly.

In addition, the adjustment pad 124 may be used to adjust the vertical position at which a transmission is held. Referring to FIG. 2B, which illustrates a front view of the adjustment pad 124, it can be seen that the adjustment pad may be manufactured to various thicknesses. Thus, in use, the adjustment pad 124 may be positioned between a transmission and the body 104 to alter the vertical position of the transmission. It is noted that the adjustment pad 124 may be optional in one or more embodiments, such as where the body 104 itself holds a transmission at a desired location.

It is noted that the elongated structure of the universal cross member 120 will have a thickness as well, as can be seen from the front view of FIG. 2A. In one or more embodiments, the universal cross member 120 may be generally planar, such as shown in FIG. 2A. It is contemplated that the universal cross member 120 may be a flat planar material that is bent or formed to have a shape like that shown in FIG. 2A. Alternatively, the universal cross member 120 may be poured, molded, or stamped to have such a shape.

In one or more embodiments, the universal cross member 120 may comprise one or more rigid materials such as one or more metals, alloys, plastics or the like. In one preferred embodiment, the universal cross member 120 may be made from aluminum. Traditionally, transmission mounts are made from steel. Aluminum is advantageous in that it provides a lightweight and strong structure while allowing flexibility. This flexibility is desirable for mounting the transmission, especially in high horsepower drive trains where the power of the engine causes drive train components to move, such as when the engine is revved. The flexibility reduces stresses on the drive train by absorbing some of the movement caused by the engine thus reducing wear and tear and increasing reliability.

As can be seen in FIG. 2A, the elongated structure of the universal cross member 120 may comprise one or more bent or angled portions to elevate the body 104 of the transmission cross member. In one or more embodiments, these angles may be different depending on the material(s) used to construct the transmission cross member 120. For example, the angle shown in FIG. 2A may be used for aluminum transmission cross members 120. The angle chosen may be selected based on characteristics of the material used. For example, in the case of aluminum, the angle may be relatively shallow to avoid a 90° bend where the aluminum may become weakened. This allows the body 104 to achieve the desired elevation while bending or forming the aluminum in such manner that preserves its strength.

Though desirable for its strength, light weight, and corrosion resistance, transmissions have not traditionally been mounted using aluminum, in part, because it is more difficult to form aluminum than more common materials such as steel. As can be seen from the above, the universal cross member 120 is able to take advantage of the benefits of aluminum in securing and mounting transmissions, while being durable and extremely reliable. This is, at least in part, because of the forming process used in constructing the transmission cross member 120 that produces an elevated body 104 using low angle bends.

The universal cross member 120 may be constructed by forming a material into the configuration disclosed herein. This may occur by milling a material, such as aluminum to produce the body 104 and arms 108 described above. Alternatively the molten or pliable material may be molded into the body 104 and arms 108 of the universal cross member 120 and then hardened. It is contemplated that a material may be bent and cut to form the universal cross member 120 as well.

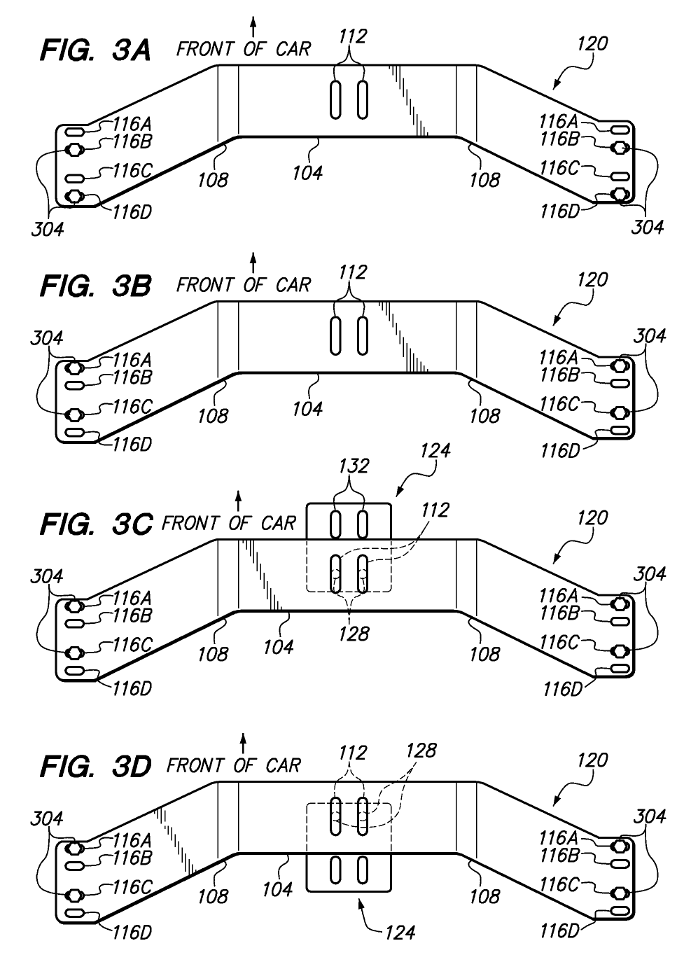

Various configurations and uses of the universal cross member will now be described with regard to FIGS. 3A-3D. FIGS. 3A-3D provide top views of the universal cross members 120. The arrows shown point toward the front of a vehicle to indicate the orientation of the universal cross members 120 when installed in a vehicle.

Referring to FIG. 3A, it can be seen that the position of the universal cross member 120 within a vehicle may be adjusted be selecting particular throughbores 116 to use in mounting the universal cross member within a vehicle. For example, in FIG. 3A, throughbores 116B,116D have been selected for use. By fastening the universal cross member 120 with throughbores 116B,116D the universal cross member may be secured at a first position relative to the vehicle. This places the body 104 and elongated slots 112 of the universal cross member 120 at a particular position within the vehicle.

Referring to FIG. 3B, it can be seen, that different throughbores 116 may be used to mount the universal cross member 120 at different locations within a vehicle. For example, as shown in FIG. 3B, the location of the universal cross member 120 may be adjusted backward from the front of a vehicle by using throughbores 116A,116C to mount the universal cross member to the vehicle. This in turn positions the body 104 and elongated slots 112 of the universal cross member 120 back from the front of the vehicle.

The ability to position the body 104 (and elongated slots 112) of the universal cross member 120 is highly beneficial in that it permits a wide variety of drive train components to be used in a wide variety of vehicles. For example, even transmissions not in existence or contemplated at the time a vehicle was designed or manufactured can be properly mounted with the universal cross member 120 (at a desired pinion angle). This is highly beneficial in effectuating repairs or upgrades to existing vehicles (old or new). This allows such vehicles to take advantage of new technologies, higher efficiencies, increased capacity, etc. . . . of a different transmission. In fact, it is contemplated that a user may select virtually any transmission he or she desires and properly mount such transmission with almost any vehicle he or she owns.

To illustrate with an exemplary vehicle, in a 1970-74 Camaro (Trademark of Chevrolet), different transmissions may be mounted therein by adjusting the position of the universal cross member 120 through use of various combinations of throughbores 116. For example, 700R4, TKO600, 4L60, and 4L60E ('93-95) type transmission may be attached (at proper pinion angles) when throughbores 116B,116D are selected to mount the universal cross member 120. This is because use of throughbores 116B,116D positions the body 104 and elongated slots 112 of the universal cross member 120 closer to the front of the vehicle.

In the same or similar 1970-74 Camaro, different transmissions may be used by securing the universal cross member 120 using throughbores 116A,116D. For instance, 4L60E or 4L65E ('96 and later) type transmissions may be attached using these throughbores 116A,116D.

As the above examples show, different transmissions may be selected for their particular characteristics and installed in almost any vehicle. This allows users to select transmission better suited for towing, 4WD, racing, and/or reliability and install them in a vehicle of their choice.

FIGS. 3C-3D illustrate configurations utilizing the adjustment pad 124. As can be seen, the adjustment pad 124 may be attached to the elongated structure of the universal cross member 120 via the openings 128 of the adjustment pad 124 and the elongated slots 112 of the universal cross member. As discussed above, since the adjustment pad 124 has a thickness, it may be used to elevate or raise a transmission over the body 104 of the universal cross member 120.

In addition, the adjustment pad 124 may be use to hold a transmission at various locations. For example, as shown in FIG. 3C-3D, the adjustment pad 124 can be secured at various positions along the elongated slots 112 of the universal cross member 120. This locates the elongated slots 132 of the adjustment pad 124 at various locations as desired to properly attach to and secure a transmission.

In FIG. 3C, the adjustment pad 124 extends forward from the universal cross member's elongated structure while in FIG. 3D, the adjustment pad extends rearward from the elongated structure. This allows a variety of transmissions to be mounted. Referring again to the exemplary 1970-74 Camaro for instance, a forward extending position (such as shown in FIG. 3C) may be used to mount a first set of transmissions. For example, Muncie, BW T10, TH350, Powerglide, and/or Richmond 5 Speed transmission may be secured to the elongated slots 132 of the adjustment pad 124 when the pad is in the forward position. It is noted that the height or thickness of the adjustment pad 124 also elevates these transmissions such that a desired pinion angle can be achieved. It is contemplated that adjustment pads 124 of various thickness may be provided to allow the user to select from various elevations at which a transmission is to be mounted. In addition or alternatively, a plurality of adjustment pads 124 may be stacked to achieve a desired height.

In a rearward or backward extending position, the adjustment pad 124 may secure a second set of transmissions. For the 1970-74 Camaro for example, TH400 or 200R4 type transmission could be secured to the adjustment pad 124 when in a rearward extending position.

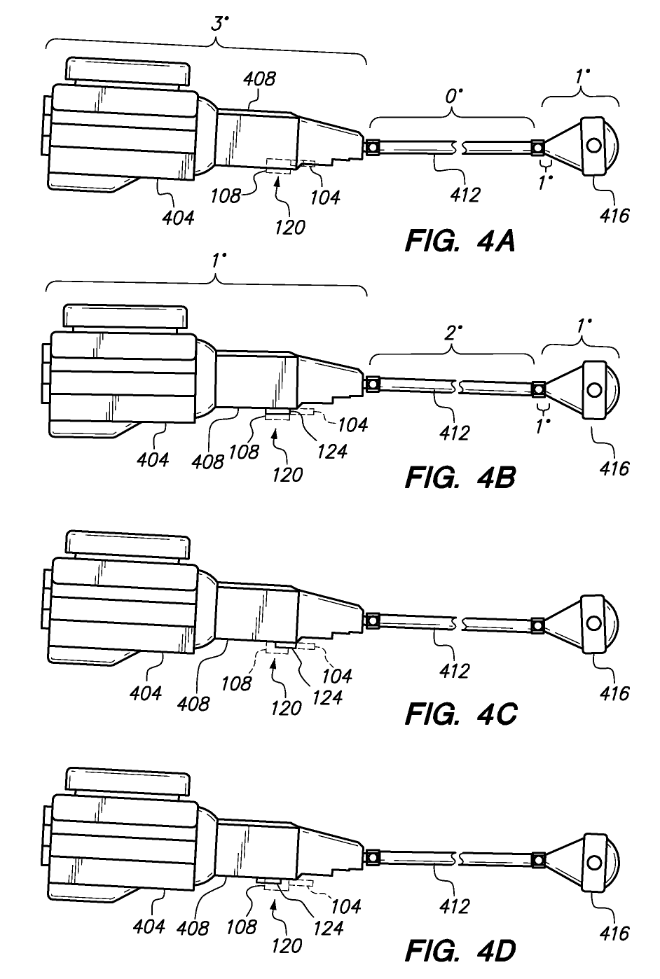

As can be seen, the combination of throughbores 116 and the adjustment pad 124 create a large number of possible locations at which a transmission may be attached and secured within a vehicle. The throughbores 116 may be used to move a transmission forward or backward, while the adjustment pad 124 may be used to raise (to various elevations) and move the transmission forward or backward. This permits transmissions of various shapes and sizes to be secured to a vehicle, and allows a number of pinion angles may be generated in this way, as will now be described with regard to FIG. 4A-4D.

FIGS. 4A-4D provide side views of a vehicle's drive train, including its engine 404, transmission 408, drive shaft 412, and differential 416. As can be seen, the transmission 408 may be secured to the universal cross member 120. The side views provided illustrate the universal cross member 120 in a rigid state for illustrative purposes. It is noted that, under the load of the transmission 408 and/or other drive train components, the universal cross member 120 may flex or bend, such as to flatten out its camber (i.e., lower the body 104 relative to the arms 108). The location at which the transmission 408 is held may change the angle of the drive shaft 412 relative to the differential 416 which results in a change in pinion angle as will now be described.

It is noted that in FIGS. 4A-4D the universal transmission mount 120 is shown with its body 104 lower than its arms 108, such as shown in FIG. 2A. It is contemplated that the universal transmission mount 120 may be secured within a vehicle with its body 104 above its arms 108 if desired. For example, if a particular transmission 404 requires a high mounting position, it is contemplated that the universal transmission mount 120 may be secured with its body 104 above its arms 108.

FIG. 4A shows a transmission 408 mounted directly to the body 104 of a universal cross member 120. As can be seen, this creates a particular pinion angle of −1° between the drive shaft 412 and the differential 416. In the example of FIG. 4A, the transmission is at 3°, while the drive shaft 412 and differential 416 are at 0° and 1° respectively.

FIG. 4B illustrates a transmission 408 mounted to the body 104 of a universal cross member 120 via an adjustment pad 124. As can be seen this results in the transmission 408 being mounted above the body 104. In the example of FIG. 4B this tilts the transmission 408 upward such that it is now at 1°. In turn, the drive shaft 412 is moved to 2° resulting in a pinion angle of 1° between the drive shaft and differential 416.

It can thus be seen that by adding or removing the adjustment pad 124, the transmission 408 may be raised or lowered, thus altering the pinion angle by altering the angle at which the drive shaft 412 is positioned. It can also be seen that adjustment pads 124 of various heights may be used to produce a desired pinion angle between a drive shaft 412 and differential 416 by raising or lowering the transmission 408. It is contemplated that by using or not using an adjustment pad 124 the angle between the drive shaft 412 and transmission 408 may be altered.

FIGS. 4C-4D illustrate use of an adjustment pad 124 to properly secure a transmission 408 to a vehicle. In FIG. 4C, the adjustment pad 124 has been secured at a rearward position relative to the body 104 of the universal cross member 120. This allows one or more holes, elongated slots, or other attachments to be aligned with the mounting structures of a transmission 408. For example, openings, bolt holes, or bolts of a transmission 408 may be aligned with elongated slots of an adjustment pad 124 by positioning the adjustment pad in a rearward position. In this manner, the transmission 408 may be securely attached to the vehicle according to its design specification.

It can be seen that the ability to secure the adjustment pad 124 at various locations can be used to accommodate a variety of transmission 408. For instance, FIG. 4D shows an adjustment pad 124 secured forward of the body 104 of the universal cross member 120 to align with the mounting structures of the transmission 408 shown. The transmission 408 may then be bolted or otherwise secured to the universal cross member 120 and thus to the vehicle.

In addition, as disclosed above, the adjustment pad 124 and the body 104 of the universal cross member 120 may have elongated slots. These elongated slots provide enlarged openings to accept fasteners, such as bolts. In this manner, bolts or other fasteners may secure a transmission's having mounting structures at different locations by extending through the elongated slots. It is contemplated that the elongated slots may be spaced apart various distances to accommodate the spacing of mounting structures on a transmission 408. In addition or alternatively, one or more pairs or individual elongated slots may be provided for the same purpose. It is contemplated that the elongated slots may be angled at a non-parallel angle relative to one another thus allowing the elongated slots to accept fasteners that are spaced various distances apart.

Referring to FIGS. 1B, 1C, 1E, and 2C, some exemplary dimensions will now be provided for the reference indicators X1-X41, R1-R6, and A1-A2. In general, these dimensions are beneficial in that they have been discovered to allow the universal cross member to mount a wide variety of transmissions within different vehicles. It is noted that embodiments of the universal transmission mount 120 made according to these dimensions may but need not be exactly these dimensions. For example, a range of dimensions at or near those provided below may be used.

| Reference No. | Dimension |
|---|---|
| X1 | 32.751″ |
| X2 | 11.293″ |
| X3 | 10.164″ |
| X4 | 11.293″ |
| X5 | 9.154″ |
| X6 | 2.14″ |
| X7 | 2.14″ |
| X8 | 9.154″ |
| X9 | 1.625″ |
| X10 | 1.5″ |
| X11 | 1.625″ |
| X12 | 4.75″ |
| X13 | 0.7″ |
| X14 | 1.0″ |
| X15 | 2.3″ |
| X16 | 1.0″ |
| X17 | 5.0″ |
| X18 | 31.875″ |
| X19 | 0.563″ |
| X20 | 0.375″ |
| X21 | 30.375″ |
| X22 | 0.563″ |
| X23 | 15.521″ |
| X24 | 1.5″ |
| X25 | 14.854″ |
| X26 | 0.75″ |
| X27 | 1.0″ |
| X28 | 1.375″ |
| X29 | 1.0″ |
| X30 | 0.75″ |
| X31 | 4.875″ |
| X32 | 7.75″ |
| X33 | 31.875″ |
| X34 | 9.382″ |
| X35 | 1.579″ |
| X36 | 9.953″ |
| X37 | 1.579″ |
| X38 | 9.382″ |
| X39 | 0.75″ |
| X40 | 0.249″ |
| X41 | 1.499″ |
| R1 | 0.25″ |
| R2 | 0.25″ |
| R3 | 0.219″ |
| R4 | 0.25″ |
| R5 | 0.75″ |
| R6 | 0.75″ |
| A1 | 135.0° |
| A2 | 133.395° |

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A universal cross member for securing a transmission within a vehicle comprising:
a body having one or more elongated slots therein, the one or more elongated slots configured to accept a fastener at one or more points along its length to secure the transmission to the body;
a pair of cambered support arms extending outward from opposite sides of the body, the pair of support arms;
to a plurality of throughbores at the distal ends of the each support arms, the plurality of throughbores configured to accept a fastener to secure the universal cross member to the vehicle; and
a sloped section at the proximal end of each of the support arms, the sloped sections configured to position the pair of support arms at a different elevation than the body.

2. The universal cross member of claim 1, wherein the sloped sections are angled portions between each of the pair of support arms and the body.

3. The universal cross member of claim 1, wherein the sloped sections comprise one or more angles to cause the pair of support arms to be cambered while holding the pair of support arms and body are at different elevations.

4. The universal cross member of claim 1, wherein the body has a front end and a rear end and the pair of support arms extend at an angle rearward from the body.

5. The universal cross member of claim 1, wherein the distal ends of the pair of support arms each have at least two throughbores at different positions at the distal ends of the pair of support arms.

6. The universal cross member of claim 1 further comprising an adjustment pad having one or more elongated slots therein, the adjustment pad secured to the body.

7. The universal cross member of claim 1, wherein the universal cross member is formed from aluminum.

8. A universal cross member for securing a transmission comprising:
a planar body having one or more elongated slots therein, the one or more elongated slots configured to accept a fastener along their lengths to secure the transmission to the planar body;
a first arm extending outward from a first side of the planar body, the first arm comprising one or more first throughbores at its distal end;
a second arm extending outward from a second side of the planar body, the second arm comprising one or more second throughbores at its distal end; and
one or more vertical angles in the first arm and the second arm configured to position at least the distal end of the first arm and at least the distal end of the second arm at a different elevation than the planar body.

9. The universal cross member of claim 8 further comprising one or more horizontal angles in the first arm and the second arm configured to position at least the distal end of the first arm and at least the distal end of the second arm forward or rearward of the body.

10. The universal cross member of claim 8, wherein the body comprises a plurality of elongated slots that are substantially parallel to one another.

11. The universal cross member of claim 8, wherein the one or more first throughbores are larger than the one or more second throughbores in at least one dimension.

12. The universal cross member of claim 8, wherein the one or more vertical angles cause the first arm and the second arm to be substantially parallel to the body while at a lower elevation than the body.

13. The universal cross member of claim 8 further comprising a planar adjustment pad comprising one or more openings, the adjustment pad attached to the body.

14. The universal cross member of claim 13, wherein the planar adjustment pad is attached to the body by one or more fasteners inserted into the one or more openings of the planar adjustment pad and the one or more elongated slots of the body.

15. A method for securing a transmission within a vehicle comprising:
positioning a universal cross member comprising a body, a first arm, and a second arm within the vehicle such that the body is at a different elevation than at least a portion of the first arm and at least a portion of the second arm;
selecting at least one first throughbore at a distal end of the first arm of the universal cross member;
attaching the distal end of the first arm to a portion of the vehicle using the at least one selected first throughbore;
attaching a distal end of the second arm of the universal cross member to another portion of the vehicle;
locating one or more fasteners along the length of one or more elongated slots in the raised body to align the one or more fasteners with one or more mounting structure of the transmission; and
securing the transmission to the body by inserting the one or more fasteners into the one or more elongated slots.

16. The method of claim 15 further comprising selecting at least one second throughbore at a distal end of the second arm of the universal cross member, wherein the distal end of the second arm is attached to the vehicle using the selected at least one second throughbore.

17. The method of claim 15 further comprising attaching an adjustment pad to the body of the universal cross member, wherein the transmission is secured to the one or more elongated slots of the adjustment pad.

18. The method of claim 17 further comprising positioning the adjustment pad to extend forward from the body of the universal cross member.

19. The method of claim 17 further comprising positioning the adjustment pad to extend rearward from the body of the universal cross member.

20. The method of claim 15 further comprising:
selecting at least one second throughbore at a distal end of the first arm of the universal cross member;
attaching the distal end of the first arm to a portion of the vehicle using the at least one second selected throughbore; and
securing a different transmission to the body by inserting the one or more fasteners into the one or more elongated slots.
